(19) United States
(12) Patent Application Publication
(10) Pub. No.: US 2024/0349238 A1
(43) Pub. Date: Oct. 17, 2024

(54) COMMUNICATION PROCESSING METHOD AND APPARATUS, TERMINAL DEVICE AND ACCESS NETWORK DEVICE

(71) Applicant: GUANGDONG OPPO MOBILE TELECOMMUNICATIONS CORP., LTD., Dongguan (CN)

(72) Inventors: Xue LIN, Dongguan (CN); Haitao LI, Dongguan (CN); Xin YOU, Dongguan (CN)

(21) Appl. No.: 18/755,552

(22) Filed: Jun. 26, 2024

Related U.S. Application Data
(63) Continuation of application No. PCT/CN2021/141674, filed on Dec. 27, 2021.

(51) Int. Cl. H04W 68/00; H04W 76/27

(52) U.S. Cl. CPC H04W 68/00; H04W 76/27

(57) ABSTRACT

Provided is a communication processing method. The method includes: a terminal device in an inactive state receives a paging message, wherein the paging message incudes first indication information, and the first indication information is used for indicating that a network side triggers mobile terminated-small data transmission (MT-SDT); and the terminal device resumes at least part of radio bearers from suspended radio bearers, wherein the at least part of radio bearers are used for receiving to-be-transmitted data corresponding to the MT-SDT. Further provided are a terminal device and a target access network device.

### CROSS-REFERENCE TO RELATED APPLICATION

This is a continuation of International Application No. PCT/CN2021/141674 filed on Dec. 27, 2021, the disclosure of which is hereby incorporated by reference in its entirety.

### TECHNICAL FIELD

Embodiments of the disclosure relate to the technical field of mobile communications, and in particular to a method and apparatus for communication processing, a terminal device, and an access network device.

### BACKGROUND

In a 5th Generation Mobile Communication Technology (5G) system, a new Radio Resource Control (RRC) state, i.e., an RRC inactive state (RRC_INACTIVE), is introduced by considering from the perspective of saving energy.

A communication system usually keeps a terminal device with infrequent data transmission in the RRC_INACTIVE state. When the terminal device in the RRC_INACTIVE state needs to receive data, the terminal device needs to resume connection with a network side, and release resources and enter the RRC_INACTIVE state again after data transmission is completed. However, such transmission mechanism may cause unnecessary power consumption and signaling overhead for a terminal device with a small data amount and a low transmission frequency.

### SUMMARY

Embodiments of the disclosure provide a method and apparatus for communication processing, a terminal device, and an access network device.

According to a first aspect, there is provided a method for communication processing, applicable to a terminal device in an inactive state. The method includes the following operations.

A paging message is received. The paging message includes first indication information, and the first indication information is configured for indicating that a network side triggers Mobile Terminated Small Data Transmission (MT-SDT).

At least part of radio bearers are resumed from suspended radio bearers. The at least part of radio bearers are configured for receiving to-be-transmitted data corresponding to the MT-SDT.

According to a second aspect, there is provided a method for communication processing, applicable to a source access network device. The method includes the following operations.

To-be-transmitted data and/or third indication information are received. The to-be-transmitted data is used for a terminal device, and the third indication information is configured for indicating a data amount of the to-be-transmitted data.

A paging message is sent in a Radio access network Notification Area (RNA) range in case that the data amount of the to-be-transmitted data is less than or equal to a preset threshold. The paging message includes first indication information, and the first indication information is configured for indicating that a network side triggers MT-SDT for the terminal device.

According to a third aspect, there is provided a method for communication processing, applicable to a target access network device. The method includes the following operations.

A paging indication message sent by a source access network device is received. The paging indication message includes first indication information and terminal identity (ID) information, and the first indication information is configured for indicating that a network side triggers MT-SDT for a terminal device.

A paging message is sent to a terminal device of which ID information is matched with the terminal ID information. The paging message includes the first indication information, and the terminal device is in an inactive state.

According to a fourth aspect, an embodiment of the disclosure provides a terminal device, including a processor and a memory. The memory is configured to store a computer program, and the processor is configured to call and run the computer program stored in the memory to execute the method of the first aspect.

According to a fifth aspect, an embodiment of the disclosure provides an access network device. The access network device may be the source access network device in the above solutions or the target access network device in the above solutions, and the access network device includes a processor and a memory. The memory is configured to store a computer program, and the processor is configured to call and run the computer program stored in the memory to execute the method of the second aspect or the third aspect.

### BRIEF DESCRIPTION OF THE DRAWINGS

The drawings described here are intended to provide a further understanding of the disclosure and constitute a part of the disclosure, and illustrative embodiments of the disclosure and descriptions thereof are intended to explain the disclosure, and do not constitute an improper limitation to the disclosure. In the drawings:

FIG. 1 is a schematic architecture diagram of a communication system provided in an embodiment of the disclosure.

FIG. 2 is a schematic diagram of an air interface transmission process of a Mobile Originated Small Data Transmission (MO-SDT) mechanism provided in an embodiment of the disclosure.

FIG. 3 is a schematic diagram of an air interface transmission process of an MT-SDT mechanism provided in an embodiment of the disclosure.

FIG. 4 is a first schematic flowchart of a method for communication processing provided in an embodiment of the disclosure.

FIG. 5 is a second schematic flowchart of a method for communication processing provided in an embodiment of the disclosure.

FIG. 6 is a third schematic flowchart of a method for communication processing provided in an embodiment of the disclosure.

FIG. 7 is a fourth schematic flowchart of a method for communication processing provided in an embodiment of the disclosure.

FIG. 8 is a fifth schematic flowchart of a method for communication processing provided in an embodiment of the disclosure.

FIG. 9 is a first schematic diagram of structural composition of an apparatus for communication processing provided in an embodiment of the disclosure.

FIG. 10 is a second schematic diagram of structural composition of an apparatus for communication processing provided in an embodiment of the disclosure.

FIG. 11 is a third schematic diagram of structural composition of an apparatus for communication processing provided in an embodiment of the disclosure.

FIG. 12 is a schematic structural diagram of a communication device provided in an embodiment of the disclosure.

FIG. 13 is a schematic structural diagram of a chip according to an embodiment of the disclosure.

FIG. 14 is a schematic block diagram of a communication system provided in an embodiment of the disclosure.

### DETAILED DESCRIPTION

Technical solutions in the embodiments of the disclosure will be described below with reference to the drawings in the embodiments of the disclosure. It is apparent that the described embodiments are part of the embodiments of the disclosure, rather than all embodiments. Based on the embodiments of the disclosure, all other embodiments obtained by those of ordinary skill in the art without any creative work belong to the scope of protection of the disclosure.

The embodiments of the disclosure provide a method for communication processing, specifically, a terminal device in an inactive state may receive a paging message, the paging message includes first indication information, and the first indication information indicates that a network side triggers MT-SDT; and then, the terminal device in the inactive state may resume at least part of radio bearers from suspended radio bearers, and the at least part of radio bearers are configured for receiving to-be-transmitted data corresponding to the MT-SDT. That is, after the terminal device in RRC_INACTIVE is triggered to enter an MT-SDT process, the terminal device may not perform RRC state switching, instead, resumes at least part of radio bearers from the suspended radio bearers and receives downlink (DL) data through the at least resumed part of radio bearers. In this way, not only normal transmission of the DL data may be ensured, but also power consumption and signaling overhead of the terminal device may be reduced.

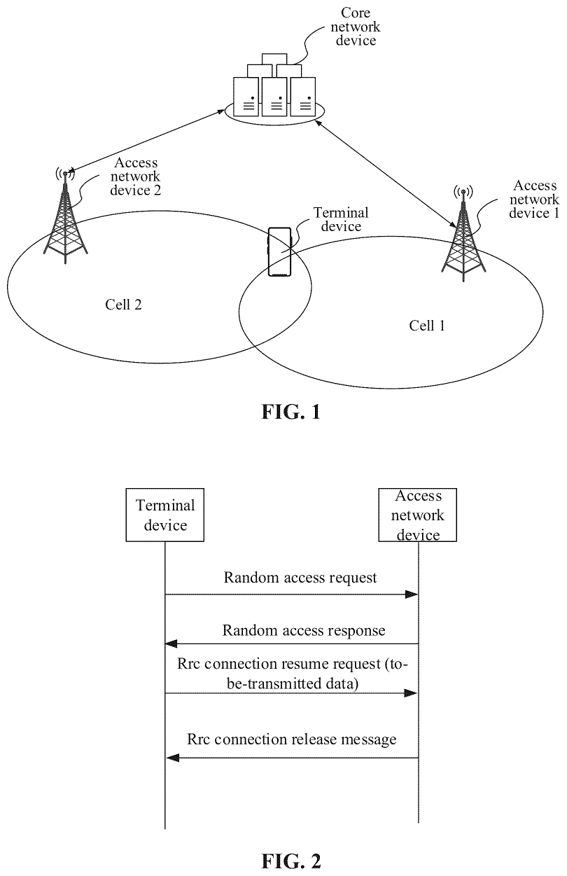

FIG. 1 illustrates a schematic architecture diagram of an exemplary communication system provided in an embodiment of the disclosure.

As illustrated in FIG. 1, the communication system may include a terminal device and an access network device. The access network device may provide communication coverage for a particular geographic area, and may communicate with a terminal device located in the coverage area. Multi-service transmission is supported between the terminal device and the access network device.

It should be understood that the embodiments of the disclosure are exemplarily described by using the communication system only, however, the embodiments of the disclosure are not limited thereto. That is, the technical solutions of the embodiments of the disclosure may be applicable to various communication systems, such as a Long Term Evolution (LTE) system, an LTE Time Division Duplex (TDD), a Universal Mobile Telecommunication System (UMTS), an Internet of Things (IoT) system, a Narrow Band Internet of Things (NB-IoT) system, an enhanced Machine-Type Communications (cMTC) system, a 5G communication system (also referred to as a New Radio (NR) communication system), or a future communication system, etc.

The access network device may be an Evolutional Node B (eNB or eNodeB) in the LTE system, or a Next Generation Radio Access Network (NG RAN) device, or a base station (gNB) in an NR system, or a radio controller in a Cloud Radio Access Network (CRAN), or the network device may be a relay station, an access point, a vehicle-mounted device, a wearable device, a hub, a switch, a bridge, a router, or a network device in a future evolved Public Land Mobile Network (PLMN), etc.

The terminal device may be any terminal device, and includes but is not limited to a terminal device connected to the network device or other terminal devices in a wired or wireless manner.

For example, the terminal device may refer to an access terminal, a User Equipment (UE), a user unit, a user station, a mobile station, a mobile platform, a remote station, a remote terminal, a mobile device, a user terminal, a terminal, a wireless communication device, a user agent, or a user device. The access terminal may be a cellular telephone, a cordless telephone, a Session Initiation Protocol (SIP) phone, an IoT device, a satellite handheld terminal, a Wireless Local Loop (WLL) station, a Personal Digital Assistant (PDA), a handheld device with a wireless communication function, a computing device, or another processing device connected to a wireless modem, a vehicle-mounted device, a wearable device, a terminal device in a 5G network, or a terminal device in a future evolved network, etc.

The terminal device may be used for Device to Device (D2D) communication.

The wireless communication system may further include a core network device in communication with an access network device. The core network device may be a 5G Core (5GC) device, such as an Access and Mobility Management Function (AMF), an Authentication Server Function (AUSF), a User Plane Function (UPF), a Session Management Function (SMF). In an example, the core network device may also be an Evolved Packet Core (EPC) device of an LTE network, such as a Session Management Function+Core Packet Gateway (SMF+PGW-C) device. It should be understood that SMF+PGW-C may simultaneously implement functions which may be implemented by SMF and PGW-C. In a network evolutional process, the core network device may also be referred to as another name, or form a new network entity by dividing functions of the core network, which is not limited in the embodiments of the disclosure.

The various functional units in the communication system may also communicate with each other by establishing connections via the next generation network (NG) interface.

For example, the terminal device establishes an air interface connection with the access network device through an NR interface for transmission of user plane data and control plane signaling. The terminal device may establish a control-plane signaling connection to the AMF via an NG interface 1 (abbreviated as N1). The access network device, such as a gNB, may establish a user-plane data connection to the UPF via an NG interface 3 (abbreviated as N3). The access network device may establish a control-plane signaling connection to the AMF via an NG interface 2 (abbreviated as N2). The UPF may establish a control-plane signaling connection to the SMF via an NG interface 4 (abbreviated as N4). The UPF may interact with a data network for user-plane data via an NG interface 6 (abbreviated as N6). The AMF may establish a control-plane signaling connection to the SMF via an NG interface 11 (abbreviated as N11). The SMF may establish a control plane signaling connection with the PCF via an NG interface 7 (abbreviated as N7).

FIG. 1 exemplarily illustrates two access network devices and one terminal device. In an example, the wireless communication system may include multiple access network devices, and a coverage range of each of the access network devices may include other numbers of terminal devices, which is not limited in the embodiment of the disclosure.

It should be noted that FIG. 1 only illustrates a system to which the disclosure is applicable by way of example; of course, the methods in the embodiments of the disclosure may also be applicable to other systems. Furthermore, terms “system” and “network” in the disclosure may usually be interchanged in the disclosure. In the disclosure, the term “and/or” is only an association relationship describing associated objects and represents that three relationships may exist. For example, A and/or B may represent three conditions: independent existence of A, existence of both A and B, and independent existence of B. In addition, character “/” in the disclosure usually represents that previous and next associated objects form an “or” relationship. It should also be understood that the term “indication” in the present disclosure may be a direct indication, an indirect indication, or an indication of an associative relationship. For example, an indication of B by A may indicate that A directly indicates B, for example, B is obtained through A, or that A indirectly indicates B, for example, A indicates C and B is obtained through C, or that there is an association between A and B. It should also be understood that the term “correspondence” in the present disclosure may indicate a direct or indirect correspondence between the two elements, or may indicate an association between the two elements, or may indicate a relationship of indicating and being indicated, configuring and being configured, etc. It should also be understood that the term “predefined” or “predefined rule” in the present disclosure may be achieved by pre-storing corresponding codes, tables or other manners for indicating relevant information in devices (e.g., including a terminal device and a network device). The specific implementation is not limited in the present disclosure. For example, “predefined” may refer to those defined in a protocol. It is also to be understood that in embodiments of the disclosure, “protocol” may refer to a standard protocol in the field of communication, which may include, for example, an LTE protocol, NR protocol and relevant protocol applied in the future communication system, which is not limited in the present disclosure.

In order to facilitate understanding the technical solutions of the embodiments of the disclosure, the related art of the embodiments of the disclosure will be described below. The following related art, as optional solutions, may be arbitrarily combined with the technical solutions of the embodiments of the disclosure, all of which belong to the scope of protection of the embodiments of the disclosure.

A Small Data Transmission (SDT) mechanism is introduced in LTE. The SDT mechanism refers to that a terminal device may be always kept in a Radio Resource Control (RRC) idle (RRC_IDLE) state, and completes uplink (UL) and/or downlink (DL) small data packet transmission without entering an RRC connected (RRC_CONNECTED) state.

The SDT may be divided into Mobile Originated Small Data Transmission (MO-SDT) and Mobile Terminated Small Data Transmission (MT-SDT). The MO-SDT may also be referred to as UL small data transmission, the MT-EDT may also be referred to as DL small data transmission, and a difference between them lies in that the SDT is triggered by a terminal side or a network side.

The MO-SDT is an SDT process initiated by the terminal side (such as a terminal device). Specifically, an MO-SDT process may include the following operations. An access network device (such as a base station) carries a maximum data amount allowed to be transmitted under the MO-SDT mechanism, in a system broadcast message. If the terminal device determines that a data amount of to-be-transmitted data is less than the maximum data amount, the terminal device may initiate an SDT process, that is, send the to-be-transmitted data in the RRC_IDLE state. Otherwise, the terminal device needs to initiate a normal connection establishment process, that is, the terminal device is switched at first from the RRC_IDLE state to the RRC_CONNECTED state, and transmits the to-be-transmitted data in the RRC_CONNECTED state.

In an actual application, the MO-SDT may be implemented based on a random access process of the terminal device. With reference to a schematic diagram of an air interface transmission process of an MO-SDT mechanism illustrated in FIG. 2, the air interface transmission process may include the following operations.

In operation 1, a terminal device sends a random access request to an access network device.

In operation 2, the access network device responds to the random access request, and sends a Random Access Response (RAR) to the terminal device.

The access network device may allocate an UL grant resource dedicated to the MO-SDT to the terminal device, to distinguish whether the current random access process is triggered by the MO-SDT.

In operation 3, the terminal device may send to-be-transmitted data by using the UL grant resource acquired from the RAR.

Specifically, the terminal device may send an RRC connection resume request to the access network device, and carry the to-be-transmitted data.

In operation 4, the access network device sends an RRC connection release message to the terminal device.

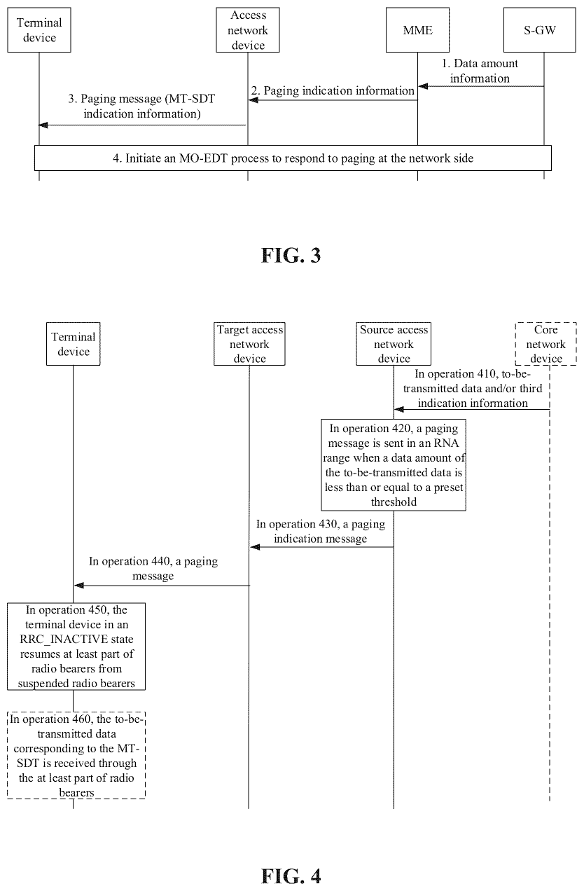

Furthermore, Mobile Terminated Small Data Transmission (MT-SDT) is an SDT process initiated by the network side (such as, a Mobility Management Entity (MME)). With reference to a schematic diagram of an air interface transmission process of an MT-SDT mechanism illustrated in FIG. 3, the air interface transmission process may include the following operations.

In operation 1, a Serving Gateway (S-GW) sends data amount information for a terminal device to an MME.

It may be understood that when to-be-transmitted data for a terminal device reaches the S-GW, the S-GW may notify the MME of data amount information of the to-be-transmitted data.

In operation 2, the MME sends paging indication information to an access network device (such as a base station), to indicate by paging the access network device to initiate a paging process for the terminal device.

The paging indication information may include the data amount information of the to-be-transmitted data and identity (ID) information of the terminal device.

In operation 3, the access network device sends a paging message to the terminal device. The paging message may carry MT-SDT indication information.

The access network device may find the terminal device by using the ID information carried in the paging indication information.

In operation 4, the terminal device confirms whether the paging message includes corresponding terminal ID and the MT-SDT indication information, and if the paging message includes the terminal ID and the MT-SDT indication information, the terminal device initiates an MO-EDT process to respond to paging at the network side.

It should be noted that only one UL/DL data transmission is supported in the SDT mechanism.

Considering from the perspective of saving energy, an RRC_INACTIVE state is introduced in a 5G system. All radio resources of a terminal device in the RRC_INACTIVE state are released, however, the terminal device and the access network device still retain context information of the terminal device, to quickly resume an RRC connection.

In general, a communication system keeps a terminal device with infrequent data transmission in the RRC_INACTIVE state. In the related art, the terminal device in the RRC_INACTIVE state does not support data transmission, and when the UL data/DL data arrives, the terminal device needs to resume the RRC connection, and release to the RRC_INACTIVE state after data transmission is completed.

However, the above transmission mechanism may cause unnecessary power consumption and signaling overhead for a terminal device with a small data amount and a low transmission frequency. At present, the 3rd Generation Partnership Project (3GPP) mainly discusses how the terminal device in RRC_INACTIVE triggers a UL SDT, i.e., the MO-SDT mechanism. At present, there is no clear solution on how the terminal device performs the MT-SDT in an inactive state.

Based on this, embodiments of the disclosure provides a method for communication processing. Specifically, a terminal device in an inactive state may receive a paging message. The paging message includes first indication information, and the first indication information is configured for indicating that a network side triggers MT-SDT; and the terminal device resumes at least part of radio bearers from suspended radio bearers, where the at least part of radio bearers are configured for receiving to-be-transmitted data corresponding to the MT-SDT. That is, after the terminal device in RRC_INACTIVE is triggered to enter an MT-SDT process, the terminal device may not perform RRC state switching, but resumes at least part of radio bearers from the suspended radio bearers, and receives DL data through the at least resumed part of radio bearers. In this way, not only normal transmission of the DL data may be ensured, but also power consumption and signaling overhead of the terminal device may be reduced.

In order to facilitate understanding the technical solutions of the embodiments of the disclosure, the technical solutions of the disclosure will be described in detail below through specific embodiments. The above related art, as optional solutions, may be arbitrarily combined with the technical solutions of the embodiments of the disclosure, all of which belong to the scope of protection of the embodiments of the disclosure. The embodiments of the disclosure include at least part of the following contents.

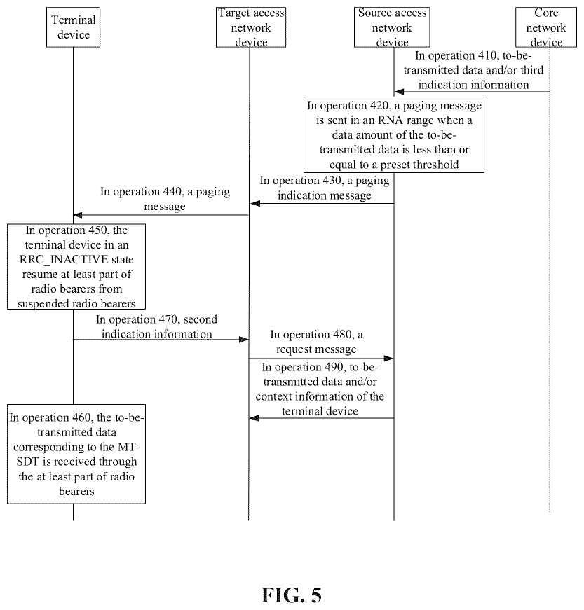

An embodiment of the disclosure provides a method for communication processing, and the method may be applicable to the communication system illustrated in FIG. 1. With reference to a schematic flowchart of a method for communication processing illustrated in FIG. 4, the method may include the following operations 410 to 450.

In operation 410, a source access network device receives to-be-transmitted data and/or third indication information.

The to-be-transmitted data is used for a terminal device, and the third indication information is configured for indicating a data amount of the to-be-transmitted data.

It should be understood that the source access network device may be an access network device corresponding to a cell where the terminal device resides when entering the RRC_INACTIVE state. The source access network device may store context information of the terminal device, and the context information may be used by the terminal device to quickly resume the RRC connection.

In an example, the source access network device may receive the to-be-transmitted data and/or the third indication information sent by the core network device. The core network device may be the AMF and/or UPF, or another network element, which is not limited in the embodiment of the disclosure.

It should be noted that the to-be-transmitted data is used for the terminal device, which may mean that the data to be transmitted is DL data for the terminal device.

It should be understood that the core network device may send only the third indication information indicating the data amount corresponding to the to-be-transmitted data to the source access network device, or may directly send the to-be-transmitted data to the source access network device, or may simultaneously send the to-be-transmitted data and the third indication information indicating the data amount corresponding to the to-be-transmitted data to the source access network device, which is not limited in the embodiment of the disclosure.

In operation 420, the source access network device sends a paging message in a Radio access network Notification Area (RNA) range in case that a data amount of the to-be-transmitted data is less than or equal to a preset threshold.

The paging message includes first indication information, and the first indication information is configured for indicating that a network side triggers MT-SDT for the terminal device.

It should be understood that after receiving the to-be-transmitted data and/or the third indication information, the source access network device may further determine whether the to-be-transmitted data meets a data amount requirement of SDT.

The data amount requirement of the SDT may be a maximum data amount allowed to be transmitted under the SDT mechanism. In the embodiment of the disclosure, the data amount requirement of the SDT may be represented by a preset threshold.

If the core network device sends the third indication information to the source access network device, the source access network device may directly compare the data amount of the to-be-transmitted data indicated by the third indication information with the preset threshold. If the data amount of the to-be-transmitted data is not greater than (that is, is less than or equal to) the preset threshold, it is determined that the data amount of the to-be-transmitted data meets the data amount requirement of the SDT.

If the core network device sends the to-be-transmitted data to the source access network device, the source access network device may calculate the data amount of the to-be-transmitted data, and compare the calculated data amount with the preset threshold. If the data amount of the to-be-transmitted data is not greater than (that is, is less than or equal to) the preset threshold, it is determined that the data amount of the to-be-transmitted data meets the data amount requirement of the SDT.

In the embodiment of the disclosure, after determining that the data amount of the to-be-transmitted data meets the data amount requirement of the SDT, the source access network device may send the paging message carrying the first indication information in the RNA range of the source access network device.

It should be noted that the first indication information may indicate that the network side triggers the MT-SDT for the terminal device, and the first indication information in the embodiment of the disclosure may also be referred to as MT-SDT indication information.

It should be understood that one or more access network devices may be included in the RNA range corresponding to the source access network device, each of the access network devices corresponds to one or more cells, and the terminal device may reside in one of the cells.

It should be noted that if an access network device corresponding to a cell where the terminal device resides currently is the source access network device, the source access network device may directly send the paging message carrying the first indication information to the terminal device, so that the terminal device performs the MT-SDT process. If the access network device corresponding to the cell where the terminal device resides currently is not the source access network device, the source access network device may send a paging indication message to the access network device (which may be referred to as a target access network device) corresponding to the cell where the terminal device resides, and carry terminal ID information and the first indication information in the paging indication message, to notify the target access network device that the network side triggers the MT-SDT for the terminal device at present, so as to facilitate the target access network device to send the paging message carrying the first indication information to the terminal device, so that the terminal device performs the MT-SDT process.

In some embodiments, if the core network device sends the to-be-transmitted data to the source access network device in the operation 410, the source access network device may further determine whether the to-be-transmitted data comes from a radio bearer supporting SDT, in addition to detecting whether the data amount of the to-be-transmitted data meets the data amount requirement of the SDT.

It should be understood that when the data amount of the to-be-transmitted data does not exceed the preset threshold and the to-be-transmitted data corresponds to the radio bearer supporting the SDT (it may also be understood as the to-be-transmitted data coming from/belonging to the radio bearer supporting the SDT), the source access network device sends the paging message (i.e., the paging message carrying the first indication information) for the terminal device in the RNA range, so that the terminal device performs the MT-SDT. Or, the source access network device may send paging indication information to the target access network device, to facilitate the target access network device to send the paging message carrying the first indication information to the terminal device, so that the terminal device performs the MT-SDT process.

If the data amount of the to-be-transmitted data exceeds the preset threshold, or the to-be-transmitted data does not correspond to the radio bearer supporting the SDT, the source access network device sends a paging message carrying no first indication information in the RNA range of the source access network device, to trigger a general data transmission process.

In operation 430, a target access network device receives a paging indication message sent by the source access network device. The paging indication message includes first indication information and terminal ID information, and the first indication information indicates that a network side triggers MT-SDT for the terminal device.

It should be understood that the target access network device may be an access [0092] network device corresponding to a cell where the terminal device resides currently.

In an example, the terminal ID information may be identification information of the terminal device, or other information which may uniquely represent identity of the terminal device, which is not limited in the embodiment of the disclosure.

It should be noted that if the target access network device and the source access network device are the same access network device, the operation 430 may be omitted and is not executed. That is, the source access network device (i.e., the target access network device) may directly send the paging message carrying the first indication information to the terminal device.

In operation 440, the target access network device sends a paging message to a terminal device of which ID information is matched with the terminal ID information. The paging message includes the first indication information.

It should be understood that after receiving the paging indication message, the target access network device may send the paging message to a terminal device of which ID information is matched with the terminal ID information carried in the paging indication message, and carry the first indication information in the paging message, so that the terminal device performs the MT-SDT process.

In operation 450, the terminal device in an RRC_INACTIVE state resumes at least part of radio bearers from suspended radio bearers. The at least part of radio bearers are configured for receiving to-be-transmitted data corresponding to the MT-SDT.

It should be understood that after receiving the paging message carrying the first indication information, the terminal device in the RRC_INACTIVE state may resume all or part of radio bearers from the suspended radio bearers, so that the to-be-transmitted data corresponding to the MT-SDT is received through the resumed radio bearers in case that the terminal device does not enter the RRC_CONNECTED state.

It should be noted that the suspended radio bearers may be understood as radio bearers which are not released, and the terminal device may quickly resume the suspended radio bearers if necessary, to transmit data through the resumed radio bearers.

In an embodiment, resuming the at least part of radio bearers in the operation 450 may include the following operations.

A radio bearer supporting SDT is resumed from the suspended radio bearers; or, all of the suspended radio bearers are resumed.

In some embodiments, if the terminal device is configured with the radio bearer supporting the SDT, the terminal device in the RRC_INACTIVE state may resume the radio bearer supporting the SDT from multiple suspended radio bearers after receiving the paging message carrying the first indication information.

In some embodiments, if the terminal device is not configured with the radio bearer supporting the SDT, the terminal device in the RRC_INACTIVE state may resume all radio bearers from multiple suspended radio bearers after receiving the paging message carrying the first indication information.

In some embodiments, even though the terminal device is configured with the radio bearer supporting the SDT, the terminal device in the RRC_INACTIVE state may resume all the radio bearers from multiple suspended radio bearers after receiving the paging message carrying the first indication information. This is not limited in the embodiment of the disclosure.

It should be noted that the radio bearer supporting the SDT may be agreed in advance by the terminal side and the network side, or may be specified in a protocol, or may be configured by the network side for the terminal device, which is not limited in the embodiment of the disclosure.

In an embodiment, the method for communication processing may further perform the following operation 460.

In operation 460, the terminal device receives the to-be-transmitted data corresponding to the MT-SDT through the at least part of radio bearers.

It should be understood that after the terminal device in the RRC_INACTIVE state resumes the at least part of radio bearers, the terminal device may receive the to-be-transmitted data through the resumed radio bearers without performing RRC state switching. In this way, not only normal transmission of DL data may be ensured, but also power consumption and signaling overhead of the terminal device may be reduced.

In an embodiment, the radio bearer supporting the SDT may include at least one radio bearer supporting the MT-SDT, and/or at least one radio bearer supporting the MO-SDT.

In an embodiment, the radio bearer supporting the SDT may be configured by the network side for the terminal device.

In some embodiments, the following operations may be performed before the operation 450.

The terminal device receives first configuration information. The first configuration information configures the radio bearer supporting the SDT, and the radio bearer supporting the SDT supports MO-SDT and MT-SDT simultaneously.

When the network side configures radio bearers of the SDT, the network side may not distinguish the radio bearer supporting the MO-SDT from the radio bearer supporting the MT-SDT. That is, the radio bearer supporting the SDT configured by the network side may support both the MO-SDT and the MT-SDT.

In some other embodiments, the following operations may be performed before the operation 450.

The terminal device receives second configuration information. The second configuration information configures a radio bearer supporting the MT-SDT and/or a radio bearer supporting MO-SDT. The radio bearer supporting the SDT includes the radio bearer supporting the MT-SDT and/or the radio bearer supporting the MO-SDT.

When the network side configures radio bearers of the SDT, the network side may configure the radio bearer supporting the MT-SDT and the radio bearer supporting the MO-SDT separately.

Based on this, resuming the radio bearer supporting the SDT from the suspended radio bearers in the above embodiment may include the following operations.

The radio bearer supporting the MT-SDT is resumed from the suspended radio bearers.

Or, the radio bearer supporting the MT-SDT and the radio bearer supporting the MO-SDT are resumed from the suspended radio bearers.

In the method for communication processing provided in the embodiments of the disclosure, the terminal device may resume the radio bearer supporting the MT-SDT and/or the radio bearer supporting the MO-SDT, and flexibly select a radio bearer to receive the to-be-transmitted data, thereby improving flexibility of receiving data by the terminal device.

It should be noted that the first configuration information and second configuration information may be sent by the source access network device to the terminal device. Specifically, when the terminal device enters the RRC_INACTIVE state, the source access network device may configure the radio bearer supporting the SDT for the terminal device through the first configuration information or the second configuration information.

It should also be noted that the first configuration information and the second configuration information may be configured by dedicated signaling, or may be configured by RRC state configuration signaling, which is not limited in the embodiment of the disclosure.

Based on the above embodiments, with reference to FIG. 5, in the method for communication processing provided in an embodiment of the disclosure, the method may further include the following operations 470 to 490 before the operation 460.

In operation 470, the terminal device sends second indication information to the target access network device. The second indication information indicates that the terminal device determines to respond to the paging message.

It should be understood that after receiving the paging message carrying the first indication information, the terminal device in the RRC_INACTIVE state may determine whether to respond to the paging message to enter the MT-SDT process. If the terminal device determines to enter the MT-SDT process, the terminal device may send the second indication information to the target access network device, to indicate that the terminal device determines to respond to the paging message.

In an embodiment, the second indication information may include an RRC resume request (RRCResumeRequest). In this way, the terminal device may notify the network side of the cell where the terminal device resides currently through the RRCResumeRequest.

In an embodiment, the second indication information may be sent by any one of: a first random access message, where the first random access message may include MSG3 or MSG A; or a Configured Grant (CG) resource.

It should be understood that when the terminal device enters the RRC_INACTIVE state, the source access network device may reserve the CG resource for the terminal device, to facilitate subsequent transmission of specific information.

In some embodiments, if the source access network device and the target access network device are the same access network device, the terminal device may determine at first whether the source access network device configures the CG resource for the terminal device. If the source access network device configures the CG resource for the terminal device, the terminal device may select the CG resource to transmit the second indication information. If the source access network device does not configure the CG resource for the terminal device, the terminal device may transmit the second indication information through Msg3 or MsgA in an initiated random access process.

In some other embodiments, if the source access network device and the target access network device are different access network devices, the terminal device may initiate a random access process (a four-step random access process or a two-step random access process) to the target access network device, and send the second indication information through Msg3 or MsgA in the random access process.

In operation 480, the target access network device sends a request message to the source access network device. The request message is configured to request context information of the terminal device.

It should be understood that as described in the operation 410, the source access network device may be an access network device corresponding to a cell where the terminal device resides when the terminal device enters the RRC_INACTIVE state, therefore, the source access network device may store context information of the terminal device when the terminal device accesses. Based on this, after receiving the second indication information, the target access network device may request the context information of the terminal device from the source access network device.

In operation 490, the target access network device receives to-be-transmitted data and/or the context information of the terminal device sent by the source access network device.

In an example, after receiving the request message, the source access network device may select whether to send the context information of the terminal device to the target access network device.

It should be noted that when the source access network device receives the to-be-transmitted data sent by the core network device in the operation 410, the source access network device needs to send the to-be-transmitted data to the target access network device no matter whether the source access network device determines to send the context information of the terminal device to the terminal device, to ensure that the to-be-transmitted data may be correctly transmitted to the terminal device.

In some embodiments, if the source access network device selects not to send the context information of the terminal device to the target access network device, the source access network device may keep connected to the core network device, and forward the to-be-transmitted data for the terminal device to the terminal device through the target access network device. The to-be-transmitted data for the terminal device may be sent by the core network device to the source access network device in advance in the operation 410, or may be requested by the source access network device from the core network in the current operation, which is not limited in the embodiments of the disclosure.

In some other embodiments, if the terminal device resumes only the radio bearer supporting the SDT, and the source access network device determines to send the context information of the terminal device to the target access network device, the target access network device may perform the following operations after receiving the context information of the terminal device:
receiving to-be-transmitted data sent by a core network device, where communication connection between the target access network device and the core network device is established based on the context information of the terminal device;
if the to-be-transmitted data corresponds to a radio bearer supporting SDT, sending the to-be-transmitted data to the terminal device through the radio bearer supporting the SDT; and
if the to-be-transmitted data does not correspond to the radio bearer supporting the SDT, sending third indication information to the terminal device, where the third indication information is configured to trigger the terminal device to enter a connected state.

It should be understood that after receiving the context information of the terminal device, the target access network device may establish a communication connection (such as a General packet radio service Tunneling Protocol (GTP) tunnel) with the core network device according to the context information. In this way, the target access network device may directly interact with the core network device through the communication connection, and receive the to-be-transmitted data sent by the core network device for the terminal device.

It should be noted that after receiving the to-be-transmitted data sent by the core network device, the target access network device also needs to determine whether the to-be-transmitted data corresponds to the radio bearer supporting the SDT. This is because the terminal device may resume only the radio bearer supporting the SDT, and if the to-be-transmitted data is directly sent without performing the above determination, it may cause data transmission failure.

If the to-be-transmitted data corresponds to the radio bearer supporting the SDT, that is, the to-be-transmitted data comes from the radio bearer supporting the SDT, the to-be-transmitted data is sent to the terminal device through the radio bearer supporting the SDT. That is, the terminal device receives the to-be-transmitted data through the resumed radio bearer supporting the SDT.

Furthermore, if the to-be-transmitted data does not correspond to the radio bearer supporting the SDT, that is, the to-be-transmitted data does not come from the radio bearer supporting the SDT, the target access network device may instruct the terminal device to enter the RRC_CONNECTED state through the third indication information. In this way, the terminal device may receive the to-be-transmitted data in the RRC_CONNECTED state, and enter the RRC_INACTIVE state after reception is completed.

It should be noted that if the terminal device resumes all radio bearers in the operation 450, the target access network device may not determine the correspondence between the to-be-transmitted data and the radio bearer supporting the SDT when receiving the to-be-transmitted data, but directly sends the to-be-transmitted data to the terminal device through the resumed radio bearers.

According to the method for communication processing provided in the embodiments of the disclosure, configuration of radio bearers in the MT-SDT process is clarified. Furthermore, in the embodiments of the disclosure, after the terminal device in RRC_INACTIVE is triggered to enter the MT-SDT process, the terminal device may not perform RRC state switching, instead, resumes at least part of radio bearers from the suspended radio bearers and receives DL data through the at least resumed part of radio bearers. In this way, not only normal transmission of the DL data may be ensured, but also power consumption and signaling overhead of the terminal device may be reduced.

The method for communication processing provided in the embodiments of the disclosure will be described in detail below with reference to a specific application scenario.

As illustrated in FIG. 1, it is assumed that there are two access network devices, i.e., an access network device 1 and an access network device 2. The terminal device resides in a cell 1 where the access network device 1 is located when the terminal device enters the RRC_INACTIVE state, and the access network device 1 may store context information of the terminal device. Furthermore, after entering the RRC_INACTIVE state, the terminal device resides on a cell 2 where the access network device 2 is located. It should be understood that in the application scenario, the access network device 1 may be a source access network device of the terminal device, and the access network device 2 may be a target access network device of the terminal device.

The method for communication processing provided in the embodiments of the disclosure will be described in detail below with reference to three specific application scenarios.

### FIRST EMBODIMENT

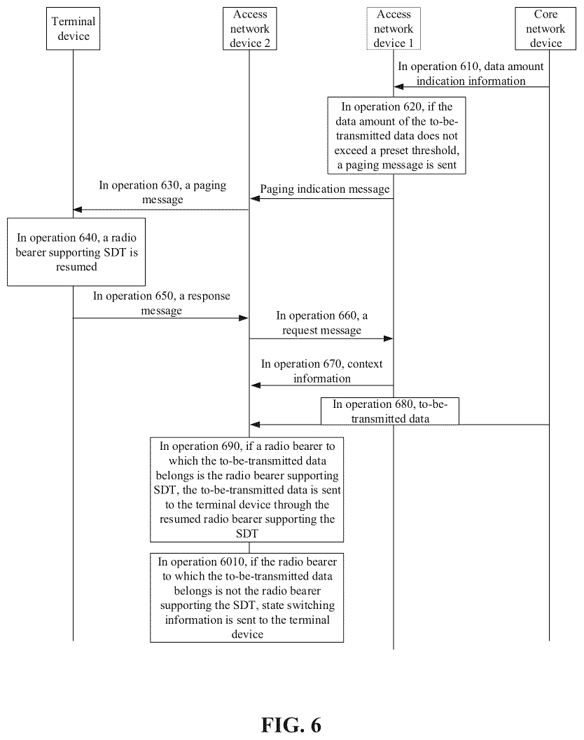

With reference to FIG. 6, the method for communication processing provided in an embodiment of the disclosure may include the following operations.

In operation 610, the access network device 1 receives data amount indication information (i.e., the third indication information in the above embodiment) sent by the core network device. The data amount indication information indicates a data amount of to-be-transmitted data.

The core network device may be the AMF and/or UPF, which is not limited in the embodiment of the disclosure.

In operation 620, if the data amount of the to-be-transmitted data does not exceed (is less than or equal to) a preset threshold, the access network device 1 sends a paging message. The paging message may include MT-SDT indication information (i.e., the first indication information in the above embodiment) and terminal ID information.

It should be noted that the access network device 1 may send the paging message within its corresponding RNA range.

In operation 630, the terminal device in the RRC_INACTIVE state receives a paging message sent by the access network device 2.

The paging message may include MT-SDT indication information and terminal ID information.

It should be understood that the access network device 2 may be located in the RNA range corresponding to the access network device 1, and the terminal device is located in a communication coverage range corresponding to the access network device 2. Based on this, the access network device 2 may receive a paging indication message sent by the access network device 1, and the paging indication message may carry the terminal ID information and the MT-SDT indication information.

After receiving the paging indication message, the access network device 2 may send the paging message to a terminal device of which ID information is matched with the terminal ID information in the communication coverage range of the access network device 2.

In operation 640, the terminal device in the RRC_INACTIVE state initiates an SDT process, and resumes a radio bearer supporting SDT.

It should be understood that after receiving the paging message, the terminal device may determine whether the paging message carries the MT-SDT indication information. If the paging message does not carry the MT-SDT indication information, the terminal device needs to initiate a normal paging response process, that is, the terminal device resumes a RRC connection, and is switched from the current RRC_INACTVIE state to the RRC_CONNECTED state to receive the to-be-transmitted data. If the paging message carries the MT-SDT indication information, the terminal device may initiate the SDT process, and receive the to-be-transmitted data without performing RRC state switching.

In the embodiment of the disclosure, after determining that the paging message carries the MT-SDT indication information, the terminal device may resume the radio bearer supporting the SDT from multiple radio bearers suspended by the terminal device, to receive the to-be-transmitted data based on the radio bearer supporting the SDT.

It should be noted that the radio bearer supporting the SDT may be configured in advance. Specifically, the radio bearer supporting the SDT may be configured by the access network device 1 (i.e., the source access network device) when the terminal device enters the RRC_INACTVIE state.

When the terminal device enters the RRC_INACTVIE state, the access network device 1 may send first configuration information or second configuration information to the terminal device through dedicated signaling, and configure the radio bearer supporting the SDT for the terminal device through the first configuration information or the second configuration information.

The first configuration information may configure the radio bearer support the SDT, and in this manner, the radio bearer supporting the SDT supports the MO-SDT and the MT-SDT simultaneously. In other words, when the radio bearer supporting the SDT is configured, the radio bearer supporting the SDT may be configured without distinguishing the MO-SDT from the MT-SDT.

Correspondingly, if the radio bearer supporting the SDT is configured through the first configuration information, resuming the radio bearer supporting the SDT in the operation 640 may be resuming all radio bearers supporting the SDT.

Furthermore, the second configuration information configures a radio bearer supporting the MT-SDT and/or a radio bearer supporting the MO-SDT; and the radio bearer supporting the SDT includes the radio bearer supporting the MT-SDT and/or the radio bearer supporting the MO-SDT.

Correspondingly, if the radio bearer supporting the SDT is configured through the second configuration information, resuming the radio bearer supporting the SDT in the operation 640 may include two solutions as follows.

In the first solution, the terminal device resumes only the radio bearer supporting the MT-SDT.

In the second solution, the terminal device resumes the radio bearer supporting the MT-SDT and the radio bearer supporting the MO-SDT simultaneously.

In operation 650, the terminal device in the RRC_INACTIVE state sends a response message (i.e., the second indication information in the above embodiment) to the access network device 2, to respond to the paging message.

In the embodiment of the disclosure, the response message may include RRCResumeRequest.

In an embodiment, the response message may be transmitted through one of Msg3, MsgA, or CG.

In some embodiments, if the access network device 1 and the access network device 2 are the same device, that is, a cell where the terminal device currently resides is the source cell, the terminal device may first determine whether there is a CG resource. If there is a CG resource, the terminal device may select the CG resource to transmit the response message. If there is no CG resource, the terminal device may transmit the response message through Msg3 or MsgA.

In some other embodiments, if the access network device 1 and the access network device 2 are different devices, the terminal device may directly select the Msg3 or MsgA to transmit the response message.

In operation 660, the access network device 2 sends a request message to the access network device 1, to request the access network device 1 to send context information of the terminal device.

It should be understood that the access network device 1 may select to transmit the context information to the access network device 2, or not transmit the context information to the access network device 2, which is not limited in the embodiment of the disclosure.

In some embodiments, if the access network device 1 does not send the context information of the terminal device to the access network device 2, the access network device 1 may keep communication with the core network device, and send the to-be-transmitted data from the core network device to the access network device 2 through an Xn-U interface, so that the access network device 2 sends the to-be-transmitted data to the terminal device in the RRC_INACTVIE state through the resumed radio bearers.

In some other embodiments, if the access network device 1 sends the context information of the terminal device to the access network device 2, the following operations 670 to 6010 may be performed.

In operation 670, the access network device 2 receives context information sent by the access network device 1, and establishes a GTP tunnel with the core network device based on the context information.

In operation 680, the access network device 2 receives to-be-transmitted data sent by the core network device, and determines whether a radio bearer to which the to-be-transmitted data belongs is the radio bearer supporting the SDT.

The access network device 2 may receive the to-be-transmitted data sent by the core network device based on the GTP tunnel established in the operation 670.

In operation 690, if a radio bearer to which the to-be-transmitted data belongs is the radio bearer supporting the SDT, the access network device 2 sends the to-be-transmitted data to the terminal device through the resumed radio bearer supporting the SDT.

In operation 6010, if the radio bearer to which the to-be-transmitted data belongs is not the radio bearer supporting the SDT, the access network device 2 sends state switching information to the terminal device, and the terminal device enters the RRC connected state through the state switching information.

### SECOND EMBODIMENT

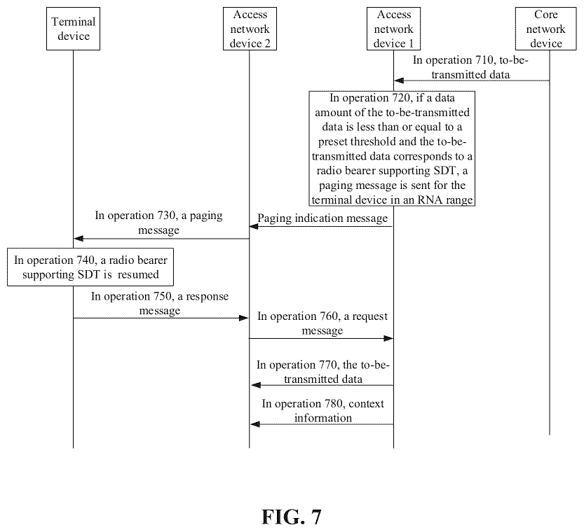

With reference to FIG. 7, the method for communication processing provided in an embodiment of the disclosure may include the following operations.

In operation 710, the access network device 1 receives to-be-transmitted data sent by the core network device.

In operation 720, if a data amount of the to-be-transmitted data is less than or equal to a preset threshold and the to-be-transmitted data corresponds to a radio bearer supporting SDT, the access network device 1 sends a paging message for the terminal device in an RNA range.

The paging message may include MT-SDT indication information and terminal ID information.

Specifically, after receiving the to-be-transmitted data, the access network device 1 may determine whether the to-be-transmitted data meets conditions as follows:
a) the data amount of the to-be-transmitted data does not exceed the preset threshold;
b) all data of the to-be-transmitted data comes from a radio bearer of MT-SDT.

If both of the two conditions are met, the access network device 1 sends the paging message for the terminal device in the RNA range.

In operation 730, the terminal device in the RRC_INACTIVE state receives a paging message sent by the access network device 2.

The paging message may include MT-SDT indication information and terminal ID information.

It should be understood that the access network device 2 may be located in the RNA range corresponding to the access network device 1, and the terminal device is located in the communication coverage range corresponding to the access network device 2. Based on this, the access network device 2 may receive a paging indication message sent by the access network device 1, and the paging indication message may carry the terminal ID information and the MT-SDT indication information.

After receiving the paging indication message, the access network device 2 may send the paging message to a terminal device of which ID information is matched with the terminal ID information in the communication coverage range of the access network device 2.

In operation 740, the terminal device in the RRC_INACTIVE state initiates an SDT process, and resumes a radio bearer supporting SDT.

It should be understood that after receiving the paging message, the terminal device may determine whether the paging message carries the MT-SDT indication information. If the paging message does not carry the MT-SDT indication information, the terminal device needs to initiate a normal paging response process, that is, the terminal device resumes a RRC connection, and is switched from the current RRC_INACTVIE state to the RRC_CONNECTED state to receive the to-be-transmitted data. If the paging message carries the MT-SDT indication information, the terminal device may initiate the SDT process, and receive the to-be-transmitted data without performing RRC state switching.

In the embodiment of the disclosure, after determining that the paging message carries the MT-SDT indication information, the terminal device may resume the radio bearer supporting the SDT from multiple radio bearers suspended by the terminal device, so as to receive the to-be-transmitted data based on the radio bearer supporting the SDT.

The manner of configuring the radio bearer supporting the SDT is the same as the configuration manner in the operation 640, which are not elaborated here for brevity.

In operation 750, the terminal device in the RRC_INACTIVE state sends a response message (i.e., the second indication information in the above embodiment) to the access network device 2, to respond to the paging message.

In the embodiment of the disclosure, the response message may include RRCResumeRequest.

In an embodiment, the response message may be transmitted through one of Msg3, MsgA, or CG.

In operation 760, the access network device 2 sends a request message to the access network device 1, to request the access network device 1 to send context information of the terminal device.

It should be understood that the access network device 1 may select to transmit the context information to the access network device 2, or not transmit the context information to the access network device 2, which is not limited in the embodiment of the disclosure.

In operation 770, the access network device 1 sends the to-be-transmitted data to the access network device 2.

It should be understood that in the second embodiment of the disclosure, the access network device 1 needs to send the to-be-transmitted data to the access network device 2 through the Xn-U interface no matter whether the access network device 1 selects to transmit the context information of the terminal device to the access network device 2, to ensure that the to-be-transmitted data may be correctly transmitted to the terminal device.

In an embodiment, the second embodiment may further include the operation 780.

In operation 780, the access network device 1 sends context information of the terminal device to the access network device 2.

It should be understood that after receiving the context information sent by the access network device 1, the access network device 2 may establish a GTP tunnel with the core network device based on the context information, and interact with the core network through the GTP tunnel.

### THIRD EMBODIMENT

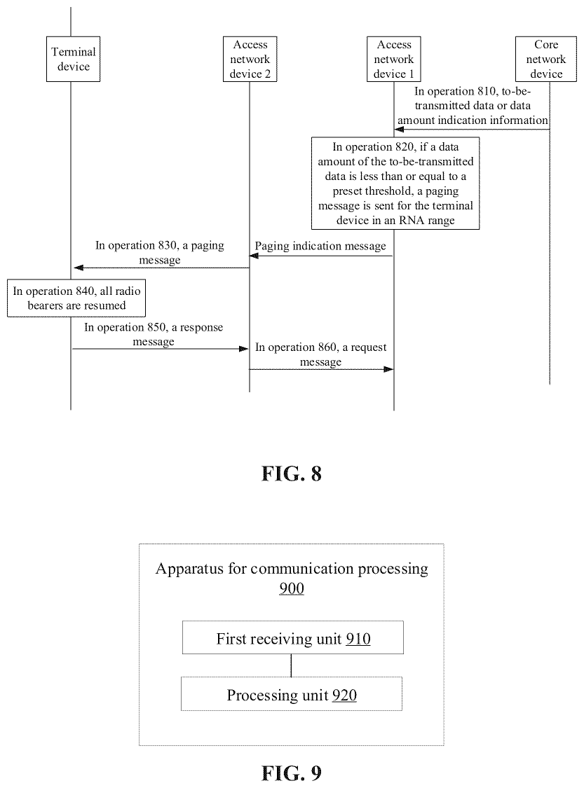

With reference to FIG. 8, the method for communication processing provided in an embodiment of the disclosure may include the following operations.

In operation 810, the access network device 1 receives data amount indication information or to-be-transmitted data sent by the core network device.

In operation 820, in case that a data amount of the to-be-transmitted data is less than or equal to a preset threshold, the access network device 1 sends a paging message for the terminal device in an RNA range.

The paging message may include MT-SDT indication information and terminal ID information.

The access network device 1 may determine the data amount of the to-be-transmitted data according to the data amount indication information directly or by calculating a size of the to-be-transmitted data sent by the core network device.

In operation 830, the terminal device in the RRC_INACTIVE state receives a paging message sent by the access network device 2.

The paging message may include MT-SDT indication information and terminal ID information.

It should be understood that the access network device 2 may be located in the RNA range corresponding to the access network device 1, and the terminal device is located in the communication coverage range corresponding to the access network device 2. Based on this, the access network device 2 may receive a paging indication message sent by the access network device 1, and the paging indication message may carry the terminal ID information and the MT-SDT indication information.

After receiving the paging indication message, the access network device 2 may send the paging message to a terminal device of which ID information is matched with the terminal ID information in the communication coverage range of the access network device 2.

In operation 840, the terminal device in the RRC_INACTIVE state initiates an SDT process, and resumes all radio bearers.

In operation 850, the terminal device in the RRC_INACTIVE state sends a response message (i.e., the second indication information in the above embodiment) to the access network device 2, to respond to the paging message.

In the embodiment of the disclosure, the response message may include RRCResumeRequest.

In an embodiment, the response message may be transmitted through one of Msg3, MsgA, or CG.

In operation 860, the access network device 2 sends a request message to the access network device 1, to request the access network device 1 to send context information of the terminal device.

It should be understood that the access network device 1 may select to transmit the context information to the access network device 2, or not transmit the context information to the access network device 2, which is not limited in the embodiment of the disclosure.

In an embodiment, if the access network device 1 receives the data amount indication information sent by the core network in the operation 810, the method for communication processing in the embodiment may further include processes of operations 670 to 6010, which are not elaborated here for brevity.

In an embodiment, if the access network device 1 receives the to-be-transmitted data sent by the core network in the operation 810, the method for communication processing in the embodiment may further include processes of operations 770 and 780, which are not elaborated here for brevity.

Preferred implementations of the disclosure have been described in detail with reference to the drawings. However, the disclosure is not limited to specific details of the above implementations. Within the scope of the technical concept of the disclosure, various simple modifications may be made to the technical solutions of the disclosure, and all these simple modifications belong to the scope of protection of the disclosure. For example, specific technical features described in the above specific implementations may be combined in any suitable way without conflict. In order to avoid unnecessary repetition, various possible combination modes will not be described in the disclosure. For another example, various different implementations according to the disclosure may be combined arbitrarily as long as the combination does not go against the concept of the disclosure, and the combination should also be deemed falling in the scope of the disclosure. For another example, various embodiments and/or technical features in various embodiments described in the disclosure may be arbitrarily combined with the related art without conflict, and technical solutions obtained after such combination should also fall within the scope of protection of the disclosure.

It should also be understood that in various method embodiments of the disclosure, a magnitude of a sequence number of each process does not mean an execution sequence and the execution sequence of each process should be determined by its function and an internal logic and should not form any limit to an implementation process of the embodiments of the disclosure. Furthermore, in the embodiments of the disclosure, the terms “downlink”, “uplink” and “sidelink” are used to indicate a direction of transmission of signals or data, “downlink” is used to indicate that the signal or data is transmitted in a first direction from a station to a UE of a cell, “uplink” is used to indicate that the signal or data is transmitted in a second direction from a UE of a cell to a station, and “sidelink” is used to indicate that the signal or data is transmitted in a third direction from UE 1 to UE 2. For example, “downlink signal” indicates that the signal is transmitted in the first direction. Further, in the embodiments of the disclosure, the term “and/or” is only an association relationship describing associated objects and represents that three relationships may exist. Specifically, A and/or B may represent three conditions: i.e., independent existence of A, existence of both A and B, and independent existence of B. In addition, character “/” in the disclosure usually represents that previous and next associated objects form an “or” relationship.

FIG. 9 is a first schematic diagram of structural composition of an apparatus for communication processing provided in an embodiment of the disclosure. The apparatus is applicable to a terminal device, and as illustrated in FIG. 9, the apparatus for communication processing 900 includes a first receiving unit 910 and a processing unit 920.

The first receiving unit 910 is configured to receive a paging message in an inactive state. The paging message includes first indication information, and the first indication information is configured for indicating that a network side triggers MT-SDT.

The processing unit 920 is configured to resume at least part of radio bearers from suspended radio bearers in the inactive state. The at least part of radio bearers are configured for receiving to-be-transmitted data corresponding to the MT-SDT.

In some embodiments, the communication apparatus 900 further includes a first sending unit. The first sending unit is configured to send second indication information in the inactive state. The second indication information is configured for indicating that the terminal device determines to respond to the paging message.

In some embodiments, the second indication information is sent by any one of: a first random access message, where the first random access message includes MSG3 or MSG A; or a CG resource.

In some embodiments, the processing unit 920 is further configured to: resume a radio bearer supporting SDT from the suspended radio bearers; or resume all of the suspended radio bearers.

In some embodiments, the first receiving unit 910 is further configured to receive first configuration information. The first configuration information configures the radio bearer supporting the SDT, and the radio bearer supporting the SDT supports MO-SDT and the MT-SDT simultaneously.

In some embodiments, the first receiving unit 910 is further configured to receive second configuration information. The second configuration information configures a radio bearer supporting the MT-SDT and/or a radio bearer supporting MO-SDT, and the radio bearer supporting the SDT includes the radio bearer supporting the MT-SDT and/or the radio bearer supporting the MO-SDT.

In some embodiments, the processing unit 920 is further configured to: resume the radio bearer supporting the MT-SDT from the suspended radio bearers; or, resume the radio bearer supporting the MT-SDT and the radio bearer supporting the MO-SDT from the suspended radio bearers.

In some embodiments, the first receiving unit 910 is further configured to receive the to-be-transmitted data corresponding to the MT-SDT through the at least part of radio bearers.

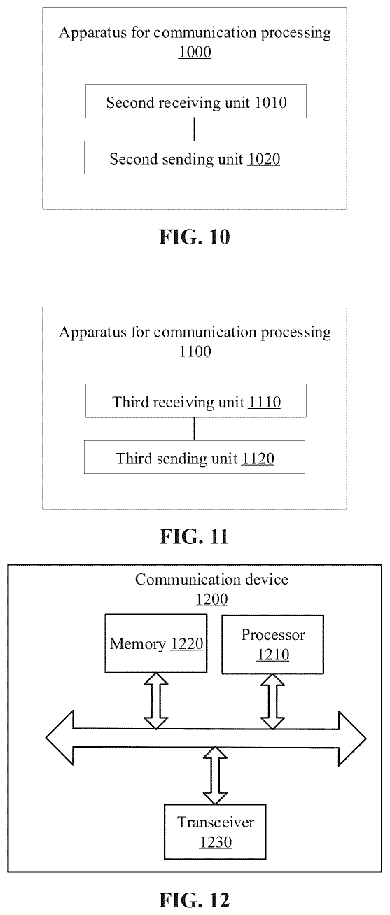

FIG. 10 is a second schematic diagram of structural composition of an apparatus for communication processing provided in an embodiment of the disclosure. The apparatus is applicable to a source access network device, and as illustrated in FIG. 10, the apparatus for communication processing 1000 includes a second receiving unit 1010 and a second sending unit 1020.

The second receiving unit 1010 is configured to receive to-be-transmitted data and/or third indication information. The to-be-transmitted data is used for a terminal device, and the third indication information is used for indicating a data amount of the to-be-transmitted data.

The second sending unit 1020 is configured to send a paging message in an RNA range in case that the data amount of the to-be-transmitted data is less than or equal to a preset threshold. The paging message includes first indication information, and the first indication information is configured for indicating that the network side triggers MT-SDT for the terminal device.

In some embodiments, if the source access network device receives the to-be-transmitted data, the second sending unit 1020 is further configured to send the paging message for the terminal device in the RNA range when the data amount of the to-be-transmitted data is less than the preset threshold and the to-be-transmitted data corresponds to a radio bearer supporting SDT.

In some embodiments, the second receiving unit 1010 is further configured to receive a request message sent by a target access network device. The request message is configured to request context information of the terminal device, and the target access network device is an access network device corresponding to a cell where the terminal device resides.

In some embodiments, the second sending unit 1020 is further configured to send the to-be-transmitted data to the target access network device.

In some embodiments, the second sending unit 1020 is further configured to send the context information of the terminal device to the target access network device.

FIG. 11 is a third schematic diagram of structural composition of an apparatus for communication processing provided in an embodiment of the disclosure. The apparatus is applicable to a target access network device, and as illustrated in FIG. 11, the apparatus for communication processing 1100 includes a third receiving unit 1110 and a third sending unit 1120.

The third receiving unit 1110 is configured to receive a paging indication message sent by a source access network device. The paging indication message includes first indication information and terminal ID information, and the first indication information is configured for indicating that a network side triggers MT-SDT for a terminal device.

The third sending unit 1120 is configured to send a paging message to a terminal device of which ID information is matched with the terminal ID information. The paging message includes the first indication information, and the terminal device is in an inactive state.

In some embodiments, the third receiving unit 1110 is further configured to receive second indication information sent by the terminal device. The second indication information is configured for indicating that the terminal device determines to respond to the paging message.

In some embodiments, the second indication information is sent by any one of: a first random access message, where the first random access message includes MSG3 or MSG A; or a CG resource.

In some embodiments, the third sending unit 1120 is further configured to send a request message to the source access network device. The request message is configured to request context information of the terminal device.

The third receiving unit 1110 is further configured to receive to-be-transmitted data and/or the context information of the terminal device sent by the source access network device.

In some embodiments, the third receiving unit 1110 is further configured to receive to-be-transmitted data sent by a core network device. Communication connection between the target access network device and the core network device is established based on the context information.

The third sending unit 1120 is further configured to send, if the to-be-transmitted data corresponds to a radio bearer supporting SDT, the to-be-transmitted data to the terminal device through the radio bearer supporting the SDT.

In some embodiments, the third sending unit 1120 is further configured to send, if the to-be-transmitted data does not correspond to the radio bearer supporting the SDT, third indication information to the terminal device. The third indication information is configured to trigger the terminal device to enter a connected state.

Those skilled in the art should understand that relevant descriptions of the above apparatus for communication processing according to the embodiment of the disclosure may be understood with reference to relevant descriptions of the method for communication processing according to the embodiments of the disclosure.

FIG. 12 is a schematic structural diagram of a communication device 1200 provided in an embodiment of the disclosure. The communication device may be a terminal device, or may be an access network device (including a source access network device and/or a target access network device). The communication device 1200 illustrated in FIG. 12 includes a processor 1210, and the processor 1210 may call and run a computer program from a memory, to implement the method in the embodiments of the disclosure.

In an example, as illustrated in FIG. 12, the communication device 1200 may further include a memory 1220. The processor 1210 may call and run a computer program from the memory 1220, to implement the method in the embodiments of the disclosure.

The memory 1220 may be a separate device independent of the processor 1210, or may be integrated in the processor 1210.

In an example, as illustrated in FIG. 12, the communication device 1200 may further include a transceiver 1230, and the processor 1210 may control the transceiver 1230 to communicate with other devices. Specifically, the processor 1210 may control the transceiver 1230 to send information or data to other devices, or receive information or data sent by other devices.

The transceiver 1230 may include a transmitter and a receiver. The transceiver 1230 may further include one or more antennas.

In an example, the communication device 1200 may specifically be the source access network device and/or the target access network device in the embodiments of the disclosure, and the communication device 1200 may implement corresponding processes implemented by the source access network device and/or the target access network device in each method of the embodiments of the disclosure, which are not elaborated here for brevity.

In an example, the communication device 1200 may specifically be the terminal device in the embodiments of the disclosure, and the communication device 1200 may implement corresponding processes implemented by the terminal device in each method of the embodiments of the disclosure, which are not elaborated here for brevity.

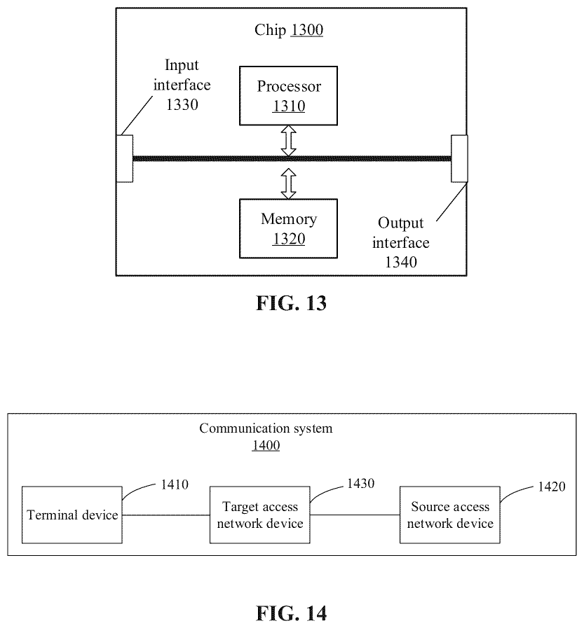

FIG. 13 is a schematic structural diagram of a chip according to an embodiment of the disclosure. The chip 1300 illustrated in FIG. 13 includes a processor 1310, and the processor 1310 may call and run a computer program from a memory, to implement the method in the embodiments of the disclosure.

In an example, as illustrated in FIG. 13, the chip 1300 may further include a memory 1320. The processor 1310 may call and run a computer program from the memory 1320, to implement the method in the embodiment of the disclosure.

The memory 1320 may be a separate device independent of the processor 1310, or may be integrated in the processor 1310.

In an example, the chip 1300 may further include an input interface 1330. The processor 1310 may control the input interface 1330 to communicate with other devices or chips. Specifically, the processor 1310 may control the input interface 1330 to acquire information or data sent by other devices or chips.

In an example, the chip 1300 may further include an output interface 1340. The processor 1310 may control the output interface 1340 to communicate with other devices or chips. Specifically, the processor 1310 may control the output interface 1340 to output information or data to other devices or chips.

In an example, the chip may be applicable to the network device in the embodiments of the disclosure, and the chip may implement corresponding processes implemented by the network device in each method of the embodiments of the disclosure, which are not elaborated here for brevity.

In an example, the chip may be applicable to the mobile terminal/terminal device in the embodiments of the disclosure, and the chip may implement corresponding processes implemented by the mobile terminal/terminal device in each method of the embodiments of the disclosure, which are not elaborated here for brevity.

It should be understood that the chip mentioned in the embodiment of the disclosure may also be referred to as a system-level chip, a system chip, a chip system, or a System on Chip (SOC) chip, etc.

FIG. 14 is a schematic block diagram of a communication system 1400 provided in an embodiment of the disclosure. As illustrated in FIG. 14, the communication system 1400 includes a terminal device 1410, a source access network device 1420, and a target access network device 1430.

The terminal device 1410 may be configured to implement corresponding functions implemented by the terminal device in the above method, the source access network device 1420 may be configured to implement corresponding functions implemented by the source access network device in the above method, and the target access network device 1430 may be configured to implement corresponding functions implemented by the target access network device in the above method, which are not elaborated here for brevity.

It should be understood that the processor in the embodiments of the disclosure may be an integrated circuit chip with signal processing capability. During implementation, each operation of the above method embodiments may be completed by an integrated logic circuit of hardware in the processor or an instruction in form of software. The processor may be a general-purpose processor, a Digital Signal Processor (DSP), an Application Specific Integrated Circuit (ASIC), a Field Programmable Gate Array (FPGA), or another programmable logical device, discrete gate or transistor logical device and discrete hardware component. Each method, operation and logical block diagram disclosed in the embodiments of the disclosure may be implemented or executed. The general-purpose processor may be a microprocessor or the processor may also be any conventional processor and the like. The operations of the method disclosed in combination with the embodiments of the disclosure may be directly embodied to be executed and completed by a hardware decoding processor or executed and completed by a combination of hardware and software modules in the decoding processor. The software module may be located in a mature storage medium in this field such as a Random Access Memory (RAM), a flash memory, a Read-Only Memory (ROM), a Programmable ROM (PROM) or an electrically erasable programmable memory, and a register. The storage medium is located in a memory, and the processor reads information in the memory, and completes operations of the above methods in combination with hardware thereof.

It may be understood that the memory in the embodiments of the disclosure may be a volatile memory or a non-volatile memory, or may include both volatile and non-volatile memories. The non-volatile memory may be a ROM, a PROM, an Erasable PROM (EPROM), an Electrically EPROM (EEPROM), or a flash memory. The volatile memory may be a Random Access Memory (RAM) used as an external cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM). It is to be noted that the memory of the system and method described in the disclosure is intended to include, but not limited to, memories of these and any other proper types.

It is to be understood that the above memory is exemplarily but unlimitedly described. For example, the memory in the embodiments of the disclosure may also be an SRAM, a DRAM, an SDRAM, a DDR SDRAM, an ESDRAM, an SLDRAM and a DR RAM. That is, the memory in the embodiments of the disclosure is intended to include but not limited to memories of these and any other proper types.

An embodiment of the disclosure further provides a computer-readable storage medium, configured to store a computer program.

In an example, the computer-readable storage medium may be applied to the network device in the embodiments of the disclosure, and the computer program enables a computer to execute corresponding processes implemented by the network device in each method of the embodiments of the disclosure, which are not elaborated here for brevity.

In an example, the computer-readable storage medium may be applied to the mobile terminal/terminal device in the embodiments of the disclosure, and the computer program enables a computer to execute corresponding processes implemented by the mobile terminal/terminal device in each method of the embodiments of the disclosure, which are not elaborated here for brevity.

An embodiment of the disclosure further provides a computer program product, including computer program instructions.

In an example, the computer program product may be applicable to the network device in the embodiments of the disclosure, and the computer program instructions enable a computer to execute corresponding processes implemented by the network device in each method of the embodiments of the disclosure, which are not elaborated here for brevity.

In an example, the computer program product may be applicable to the mobile terminal/terminal device in the embodiments of the disclosure, and the computer program instructions enable a computer to execute corresponding processes implemented by the mobile terminal/terminal device in each method of the embodiments of the disclosure, which are not elaborated here for brevity.

An embodiment of the disclosure further provides a computer program.

In an example, the computer program may be applicable to the network device in the embodiments of the disclosure, and the computer program enables a computer to execute corresponding processes implemented by the network device in each method of the embodiments of the disclosure when the computer program is run on the computer, which are not elaborated here for brevity.

In an example, the computer program may be applicable to the mobile terminal/terminal device in the embodiments of the disclosure, and the computer program enables a computer to execute corresponding processes implemented by the mobile terminal/terminal device in each method of the embodiments of the disclosure when the computer program is run on the computer, which are not elaborated here for brevity.

Those of ordinary skill in the art may realize that the units and algorithm operations of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the disclosure.

Those skilled in the art may clearly learn about that specific working processes of the system, apparatus and unit described above may refer to the corresponding processes in the method embodiments and will not be elaborated herein for convenient and brief description.

In some embodiments provided by the disclosure, it is to be understood that the disclosed system, apparatus and method may be implemented in another manner. For example, the apparatus embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between displayed or discussed components may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit.

When being realized in form of software functional unit and sold or used as an independent product, the function may also be stored in a computer-readable storage medium. Based on such an understanding, the technical solutions of the disclosure substantially or parts making contributions to the conventional art or part of the technical solutions may be embodied in form of software product, and the computer software product is stored in a storage medium, including multiple instructions configured to enable a computer device (which may be a personal computer, a server, a network device or the like) to execute all or part of the operations of the method in each embodiment of the disclosure. The abovementioned storage medium includes: various media capable of storing program codes such as a U disk, a mobile hard disk, a ROM, a RAM, a magnetic disk or an optical disk.

The above is only the specific implementation of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for communication processing, applicable to a terminal device in an inactive state, the method comprising:
receiving a paging message, wherein the paging message comprises first indication information, and the first indication information is configured for indicating that a network side triggers Mobile Terminated Small Data Transmission (MT-SDT); and
resuming at least part of radio bearers from suspended radio bearers, wherein the at least part of radio bearers are configured for receiving to-be-transmitted data corresponding to the MT-SDT.

2. The method of claim 1, further comprising:
sending, by the terminal device, second indication information, wherein the second indication information is configured for indicating that the terminal device determines to respond to the paging message.

3. The method of claim 2, wherein the second indication information is sent by any one of:
a first random access message, wherein the first random access message comprises a four-step random access message MSG3 or a two-step random access message MSG A; or
a Configured Grant (CG) resource.

4. The method of claim 1, wherein resuming the at least part of radio bearers comprises:
resuming a radio bearer supporting Small Data Transmission (SDT) from the suspended radio bearers; or
resuming all of the suspended radio bearers.

5. The method of claim 4, further comprising:
receiving first configuration information, wherein the first configuration information configures the radio bearer supporting the SDT, and the radio bearer supporting the SDT supports Mobile Originated Small Data Transmission (MO-SDT) and MT-SDT simultaneously.

6. The method of claim 4, further comprising:
receiving second configuration information, wherein the second configuration information configures a radio bearer supporting the MT-SDT and/or a radio bearer supporting Mobile Originated Small Data Transmission (MO-SDT), and the radio bearer supporting the SDT comprises the radio bearer supporting the MT-SDT and/or the radio bearer supporting the MO-SDT.

7. The method of claim 6, wherein resuming the radio bearer supporting the SDT from the suspended radio bearers comprises:
resuming the radio bearer supporting the MT-SDT from the suspended radio bearers; or
resuming the radio bearer supporting the MT-SDT and the radio bearer supporting the MO-SDT from the suspended radio bearers.

8. The method of claim 1, further comprising:
receiving the to-be-transmitted data corresponding to the MT-SDT through the at least part of radio bearers.

9. A terminal device, comprising: a processor and a memory, wherein the memory is configured to store a computer program, and the processor is configured to call and run the computer program stored in the memory to cause the terminal device to:
receive a paging message in an inactive state, wherein the paging message comprises first indication information, and the first indication information is configured for indicating that a network side triggers Mobile Terminated Small Data Transmission (MT-SDT); and
resume at least part of radio bearers from suspended radio bearers in the inactive state, wherein the at least part of radio bearers are configured for receiving to-be-transmitted data corresponding to the MT-SDT.

10. The terminal device of claim 9, wherein the terminal device is further configured to send second indication information, wherein the second indication information is configured for indicating that the terminal device determines to respond to the paging message.

11. The terminal device of claim 10, wherein the second indication information is sent by any one of:
a first random access message, wherein the first random access message comprises a four-step random access message MSG3 or a two-step random access message MSG A; or
a Configured Grant (CG) resource.

12. The terminal device of claim 9, wherein the terminal device is further configured to:
resume a radio bearer supporting Small Data Transmission (SDT) from the suspended radio bearers; or
resume all of the suspended radio bearers.

13. The terminal device of claim 12, wherein the terminal device is further configured to receive first configuration information, wherein the first configuration information configures the radio bearer supporting the SDT, and the radio bearer supporting the SDT supports Mobile Originated Small Data Transmission (MO-SDT) and MT-SDT simultaneously.

14. The terminal device of claim 12, wherein the terminal device is further configured to receive second configuration information, wherein the second configuration information configures a radio bearer supporting the MT-SDT and/or a radio bearer supporting Mobile Originated Small Data Transmission (MO-SDT), and the radio bearer supporting the SDT comprises the radio bearer supporting the MT-SDT and/or the radio bearer supporting the MO-SDT.

15. The terminal device of claim 14, wherein the terminal device is further configured to:
resume the radio bearer supporting the MT-SDT from the suspended radio bearers; or
resume the radio bearer supporting the MT-SDT and the radio bearer supporting the MO-SDT from the suspended radio bearers.

16. The terminal device of claim 9, wherein the terminal device is further configured to:
receive the to-be-transmitted data corresponding to the MT-SDT through the at least part of radio bearers.

17. A target access network device, comprising: a processor and a memory, wherein the memory is configured to store a computer program, and the processor is configured to call and run the computer program stored in the memory to cause the target access network device to:
receive a paging indication message sent by a source access network device, wherein the paging indication message comprises first indication information and terminal identity (ID) information, and the first indication information is configured for indicating that a network side triggers Mobile Terminated Small Data Transmission (MT-SDT) for a terminal device; and
send a paging message to a terminal device of which ID information is matched with the terminal ID information, wherein the paging message comprises the first indication information, and the terminal device is in an inactive state.

18. The target access network device of claim 17, wherein the target access network device is further configured to:
receive second indication information sent by the terminal device, wherein the second indication information is configured for indicating that the terminal device determines to respond to the paging message.

19. The target access network device of claim 18, wherein the second indication information is sent by any one of:
a first random access message, wherein the first random access message comprises a four-step random access message MSG3 or a two-step random access message MSG A; or
a Configured Grant (CG) resource.

20. The target access network device of claim 18, wherein the target access network device is further configured to:
send a request message to the source access network device, wherein the request message is configured to request context information of the terminal device; and
receive to-be-transmitted data and/or the context information of the terminal device sent by the source access network device.
